(19) United States
(12) Patent Application Publication
(10) Pub. No.: US 2026/0048972 A1
(43) Pub. Date: Feb. 19, 2026

(54) FALL PROTECTION SYSTEMS AND METHODS

(71) Applicant: The Boeing Company, Arlington, VA (US)

(72) Inventors: Julie Francine Sweeney, Arlington, WA (US); David Anton Danner, JR., Snohomish, WA (US); Eric Kenneth Grossmann, Snohomish, WA (US)

(73) Assignee: The Boeing Company, Arlington, VA (US)

(21) Appl. No.: 18/805,849

(22) Filed: Aug. 15, 2024

(51) Int. Cl. B66F 17/00

(52) U.S. Cl. CPC B66F 17/006

(57) ABSTRACT

A system and a method include a fall protection system having safety anchors coupled with a passenger basket of a lift system. Each of the safety anchors may receive a safety key. One or more sensors are operably coupled with the passenger basket or a base of the lift system. A controller including one or more processors receives data from the sensors. The controller determines a weight value based on the data that corresponds to one or more passengers disposed within the passenger basket. The controller determines a number of passengers that are disposed within the passenger basket based in part on the weight value. The controller controls one or more operations of the lift system based at least in part on a comparison between the number of passengers disposed within the passenger basket and a number of safety keys operably coupled with a corresponding safety anchor.

### FIELD OF THE DISCLOSURE

Examples of the present disclosure generally relate to personal fall protection systems and methods.

### BACKGROUND OF THE DISCLOSURE

Regulations exist that require all personnel using a lift system (e.g., a boom lift, a scissor lift, etc.) to be wearing a fall protection harness that is to be connected to the lift system so that the occupant may not fall out. For example, if the occupant falls from the lift, the fall distance is limited by a length of a safety lanyard or strap that extends between the protection harness worn by the operator and the passenger basket. The lanyard may have a safety key disposed at one end of the lanyard (that is opposite the end of the lanyard that is tethered to the harness of the operator) that may be coupled with one or more safety anchors of the passenger basket. The safety anchors may be electrically coupled with a control system of the lift system, and a verification process may require confirmation that each safety key is securely coupled with at least one safety anchor before movement of the lift system is allowed.

However, existing verification systems fail to consider a number of occupants that are positioned within the passenger basket when determining whether movement of the passenger basket is allowed. For example, existing fall protection systems fail to determine how many people are on the lift to ensure that the correct number of safety keys are properly connected to a corresponding safety anchor. Some fall protection systems rely on the occupants remembering to connect lanyards or safety straps to an anchor of the passenger basket. Other fall protection systems may allow for the use of a “dummy key” that may be used as a work-around to allow movement of the lift system without verification associated with the number of passengers that are actually positioned within the passenger basket.

### SUMMARY OF THE DISCLOSURE

A need exists for a fall protection system and method that automatically validates the safety for all occupants. Further, a need exists for a fall protection system that is able to determine a number of occupants that are positioned within a passenger basket, and allow and/or prohibit operation of the lift system based on the number of occupants and the state of connection between a safety key tethered to an occupant via a lanyard and a safety anchor of the passenger basket.

With those needs in mind, certain examples of the present disclosure provide a fall protection system and method that includes plural safety anchors coupled with a passenger basket of a lift system. Each of the safety anchors may receive a safety key. One or more sensors are operably coupled with the passenger basket or a base of the lift system. A controller including one or more processors receives data from the sensors. The controller determines a weight value based on the data that corresponds to one or more passengers disposed within the passenger basket. The controller determines a number of passengers that are disposed within the passenger basket based in part on the weight value. The controller controls one or more operations of the lift system based at least in part on a comparison between the number of passengers disposed within the passenger basket and a number of safety keys operably coupled with a corresponding safety anchor.

In one example, the controller prohibits the one or more operations of the lift system responsive to determining that the number of passengers disposed within the passenger basket is different than the number of safety keys operably coupled with safety anchors. In another example, the controller allows the one or more operations of the lift system responsive to determining that the number of passengers disposed within the passenger basket is the same as the number of safety keys operably coupled with safety anchors.

In another example, the controller determines that one passenger is disposed within the passenger basket based in part on the weight value. The controller allows the one or more operations of the lift system responsive to determining i) the one passenger is disposed within the passenger basket; ii) a first safety key is operably coupled with a first safety anchor; and iii) a second safety key is not operably coupled with a second safety anchor.

In one example, the controller may compare the weight value with a weight threshold. The controller may prohibit the operations of the lift system responsive to determining that the weight value exceeds the weight threshold. In another example, the controller prohibits the operations of the lift system responsive to determining that the weight value exceeds the weight threshold and that the number of passengers disposed within the passenger basket is different than the number of safety keys operably coupled with a corresponding safety anchor. In another example, the controller prohibits the operations of the lift system responsive to determining that the weight value exceeds the weight threshold and that the number of passengers disposed within the passenger basket is the same as the number of safety keys coupled with safety anchors.

In another example, the sensors may include a load cell, a weight detection device, and/or a pressure sensor. In another example, the sensors coupled with the passenger basket or the base of the lift system may include one or more weight detection devices coupled with the passenger basket and a load cell operably coupled with the base of the lift system. The weight detection devices and the load cell may be communicatively coupled with the controller.

In one example, the one or more operations of the lift system may include moving the passenger basket in a vertical direction between plural different elevations or moving the passenger basket and/or the base in a lateral direction.

Certain examples of the present disclosure provide a method that includes receiving data from sensors coupled with a passenger basket or a base of a lift system. The data is associated with a weight value corresponding to one or more passengers disposed within the passenger basket. A number of passengers disposed within the passenger basket is determined based at least in part on the weight value. The number of passengers disposed within the passenger basket is compared with a number of safety keys operably coupled with a corresponding safety anchor. Plural safety anchors are operably coupled with the passenger basket. Operation of the lift system is controlled based at least in part on the comparison between the number of passengers disposed within the passenger basket and the number of safety keys that are operably coupled with safety anchors.

Certain examples of the present disclosure provide a method that includes receiving data from sensors coupled with a passenger basket or a base of a lift system. The data is associated with a weight value corresponding to one or more passengers disposed within the passenger basket. A number of passengers disposed within the passenger basket is determined based at least in part on the weight value. The number of passengers disposed within the passenger basket is compared with a number of safety keys operably coupled with a corresponding safety anchor. Plural safety anchors are operably coupled with the passenger basket. One or more operations of the lift system may be prohibited responsive to determining that the number of passengers disposed within the passenger basket is different than the number of safety keys operably coupled with a corresponding safety anchor. Alternatively, one or more operations of the lift system may be allowed responsive to determining that the number of passengers disposed within the passenger basket is the same as the number of safety keys operably coupled with a corresponding safety anchor.

### BRIEF DESCRIPTION OF THE DRAWINGS

FIG. 1 illustrates an example of a lift system, according to an example of the present disclosure.

FIG. 2 illustrates a top view of a passenger basket of a lift system, according to an example of the present disclosure.

FIG. 3 illustrates a schematic of a controller of the passenger basket shown in FIG. 2, according to an example of the present disclosure.

FIG. 4 illustrates a schematic of the circuitry of components of a lift system, according to an example of the present disclosure.

FIG. 5 illustrates a flow chart of a method, according to an example of the present disclosure.

FIG. 6 illustrates a first example of occupant(s) positioned within a passenger basket, according to an example of the present disclosure.

FIG. 7 illustrates a second example of occupant(s) positioned within a passenger basket, according to an example of the present disclosure.

FIG. 8 illustrates a third example of occupant(s) positioned within a passenger basket, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

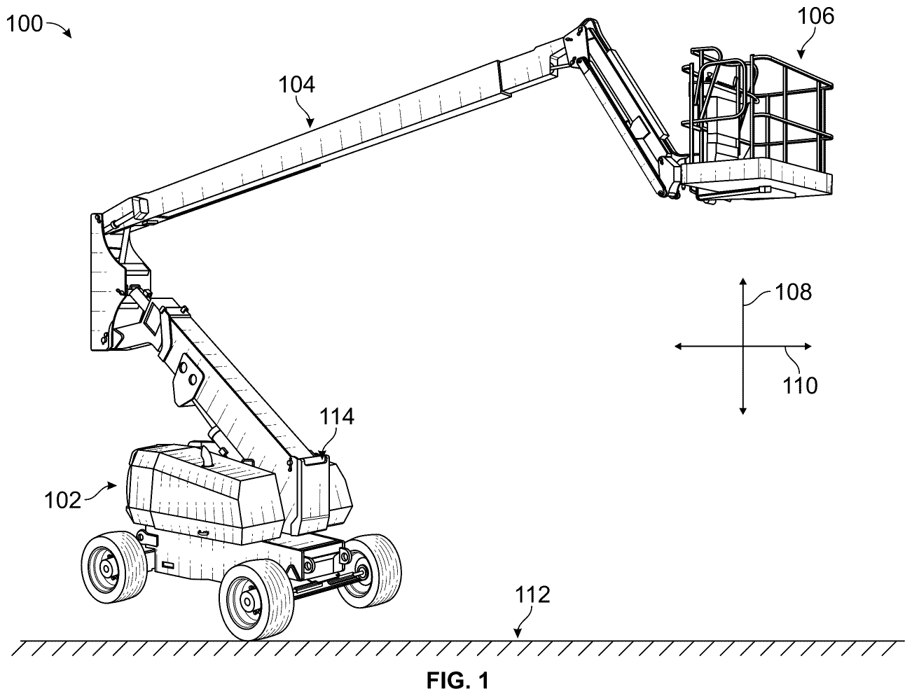

FIG. 1 illustrates a lift system 100, in accordance with one example. The lift system includes a base 102 and a passenger basket 106 with an arm 104 that extends between the base and the basket. In other examples, the lift system may be a scissor lift system, or the like, that moves occupants and/or equipment between different elevations. In the illustrated example, the lift system is a boom lift system, and the arm 104 is controlled to move the passenger basket 106 in a vertical direction 108 between a ground surface 112 and plural different elevations, and a horizontal or lateral direction 110. Additionally, the base 102 includes wheels that can be controlled to move the lift system in the horizontal direction 110.

FIG. 2 illustrates a top view of the passenger basket 106, in accordance with one example. The lift system 100 includes a fall protection system 200 that includes one or more components and/or systems disposed within and/or distributed between the passenger basket 106, the base 102, and the arm 104. The passenger basket 106 includes a basket frame 204 that is coupled with the arm (not shown in FIG. 2) at a joint 202. The passenger basket 106 includes an interior region 206 that is inside of the basket frame. For example, one or more occupants, equipment, and/or materials may be positioned within the interior region 206 of the basket frame 204 to move the occupants, equipment, and/or materials to different elevations.

The passenger basket 106 includes plural safety anchors 214A-D that are disposed at different locations around the basket frame 204. In the illustrated example, the passenger basket 106 includes four safety anchors 214A-D that are disposed at interior locations of the basket frame 204 (e.g., within the interior region 206 of the passenger basket). In another example, the passenger basket 106 may include more than four or less than four safety anchors in the interior region 206 and/or one or more safety anchors disposed at exterior locations of the basket frame 204 (e.g., outside of the basket frame). Each of the safety anchors 214A-D may be shaped and/or sized to receive a mating component, such as a safety key that secures or anchors one or more occupants to the passenger basket 106. For example, a first end of a lanyard or safety strap (not shown) may be operably coupled with at least one of the occupants (e.g., attached to the occupant such as by a harness, a carabiner, or the like), and a second end of the lanyard may be operably coupled with a safety key.

The lift system 100 also includes a controller 220. In the illustrated example, the controller is positioned within the passenger basket 106, but in alternative examples, the controller, or one or more components of the controller, may be disposed at other locations of the lift system, such as at the base 102. Each of the safety anchors 214A-D are electrically coupled with the controller 220.

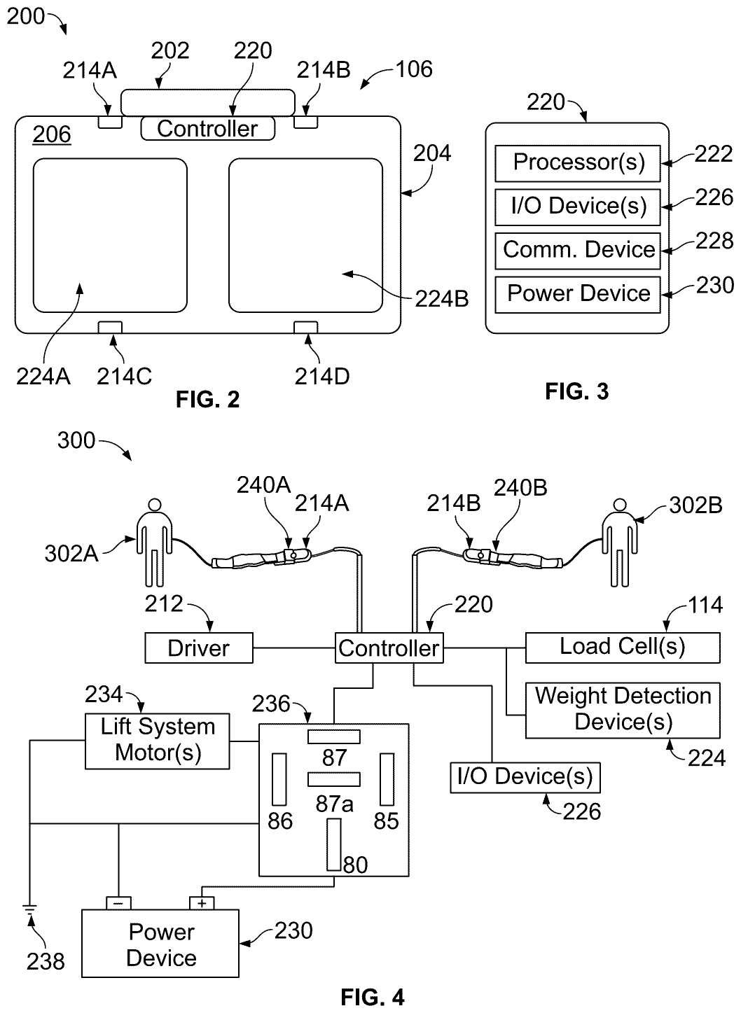

FIG. 3 illustrates a schematic of one example of the controller 220. The controller 220 includes one or more processors 222, such as one or more microprocessors, field programmable gate arrays, integrated circuits, and/or the like. In one example, the controller may include a single processor or multiple processors. All operations can be performed by each processor, or each processor may perform at least one different operation than one or more (or all) other processors.

The controller 220 also includes one or more input and/or output devices 226 (shown as “I/O Device(s) in FIG. 3). The lift system can be manually operated by receiving instruction signals from the input/output devices 226 that can represent a touchscreen, a joystick, a keyboard, a switch, a wheel, a microphone, a display, a monitor, a speaker, a light, or the like.

In one or more examples, the controller 220 can include a communication device 228 that represents transceiving hardware (e.g., antennas, wires, cables, modems, codecs, or the like) that can wirelessly communicate signals or communicate signals described herein via wired connections. The communication device may communicate with the one or more occupants and/or operators positioned within the passenger basket 106, with one or more operators positioned proximate to the base 102 of the lift system 100, with one or more operators at a control center (not shown), or the like.

The controller 220 may include a power device 230, that can represent one or more batteries, fuel cells, or the like, that may provide power to one or more systems and/or components of the lift system (e.g., propulsion loads, auxiliary loads, etc.).

Returning to FIG. 2, the controller 220 may be operably coupled with one or more sensors 224A, 224B of the passenger basket 106 and/or one or more sensors 114 of the base 102 (shown in FIG. 1). In one or more examples, the sensor(s) 114 may represent a load cell or an alternative electro-mechanical sensing device. In another example, the load cell 114 may be positioned onboard and/or operably coupled with the passenger basket. The load cell 114 may sense or detect a total weight of the passenger basket 106, the arm 104, etc.

The sensors 224A, 224B may represent weight detection devices, such as floor mats, pressure sensing devices, or the like. For example, the sensors 224A, 224B may sense or otherwise detect passengers, material, and/or equipment that are positioned on top of or otherwise in contact with the weight detection device(s).

In one example, the weight detection devices 224A, 224B positioned within the passenger basket 106 and the load cell 114 may be electrically coupled with the controller 220 via one or more of a wired or wireless connection. For example, the load cell 114 may transmit sensed data associated with the total weight of the passenger basket 106 to the controller 220. Additionally, the weight detection devices 224A, 224B may transmit sensed signals associated with occupants and/or equipment disposed within the passenger basket 106 to the controller 220. The controller 220 may determine a total weight of the passenger basket 106 and/or a total number of occupants disposed within the passenger basket 106 based on the sensed data received from the load cell 114 and/or the weight detection devices 224A, 224B.

FIG. 4 illustrates a schematic of the circuitry 300 associated with controlling operation of the lift system 100, the base 102, the arm 104, the passenger basket 106, and/or one or more systems or components of the passenger basket, in accordance with one example of the present disclosure. The controller 220 is electrically coupled with the input/output device(s) 226, the one or more sensors (e.g., the load cell 114 and the weight detection devices 224) (such as the occupant detector sensors), one or more lift system motors 234 (e.g., motors that control movement of the passenger basket, the arm 104, and/or the base 102 of the lift system 100), and the power device 230 via a relay 236. The one or more lift system motors 234, the power device 230, and the relay 236 are also electrically coupled with an electrical ground 238. The schematic shown in FIG. 4 is for illustrative purposes only. In another example, the circuitry may have an alternative configuration, may include one or more additional electrical components, may be devoid one or more components shown, or the like.

In the illustrated example, the controller 220 is also electrically coupled with a first safety anchor 214A and a second safety anchor 214B. In other examples, the controller may be electrically coupled with any number of safety anchors of the passenger basket 106. A first safety key 240A extends between a first passenger 302A and is matingly coupled with the first safety anchor 214A, and a second safety key 240B extends between a second passenger 302B and is matingly coupled with the second safety anchor 214B.

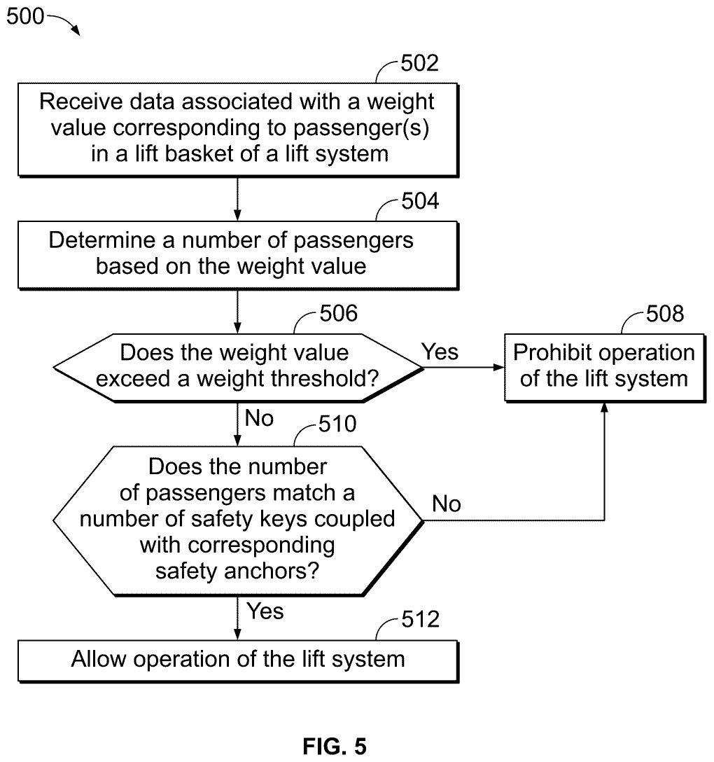

FIG. 5 illustrates a flow chart 500 of a method of controlling operation of the lift system 100. The flow chart illustrated in FIG. 5 is for illustrative purposes only and may include one or more additional steps, one or more of the steps may be completed in an alternative order, two or more of the steps may be completed substantially simultaneously, or the like.

At 502, the controller 220 receives data (e.g., from the load cell 114 and/or one or more of the weight detection devices 224A, 224B). The data may be associated with a weight value corresponding to the passenger basket 106, passengers within the passenger basket 106, material and/or equipment disposed within the passenger basket 106, or the like.

At 504, the controller 220 determines a number of passengers that are disposed within the passenger basket 106 based at least in part on the weight value. In one example, the controller 220 may determine the number of passengers and/or the equipment disposed within the passenger basket 106 based in part on predetermined weight estimates associated with a passenger, predetermined weight estimates associated with two passengers, or the like. For example, the data may indicate that a total weight of 300 pounds (lbs) is being carried by the passenger basket 106. The predetermined weight estimate of a single passenger may be about 250 lb. The controller 220 may determine that a single passenger and at least some extra materials and/or equipment are disposed within the passenger basket 106. As another example, the data may indicate that the total weight of 650 lb is being carried by the passenger basket 106. The controller 220 may determine that two passengers (e.g., representative of about 600 lb of the total weight) are disposed within the passenger basket 106 along with at least some extra materials and/or equipment. As another example, the data may indicate that a passenger is standing on the first weight detection device 224A but a second passenger is not standing on the second weight detection device 224B. Optionally, the number of total passengers may be determined based on an alternative comparison or analysis of the data conducted by the controller 220.

At 506, a determination is made if the weight value determined by the controller 220 exceeds a weight threshold. For example, the lift system 100 may have a determined weight threshold corresponding to a total amount of weight that the lift system 100 is permitted to safely carry. The controller 220 may compare the weight value detected by the load cell 114 and/or the weight detection devices 224A, 224B and compare the weight value with the determined weight threshold. If the controller 220 determines that the weight value is greater than or exceeds the determined weight threshold, flow of the method proceeds toward 508. At 508, the controller 220 prohibits one or more operations of the lift system 100. For example, the controller 220 may determine that the total weight of passengers and/or materials that are disposed within the passenger basket 106 exceeds a determined weight threshold, and may prohibit an operator from controlling movement of the lift system such as by moving the passenger basket 106 in the vertical direction 108 between plural different elevations about the ground surface 112, from moving the passenger basket 106 in the lateral direction 110, from moving the base 102 of the lift system 100 in the lateral direction 110, or the like. For example, the controller 220 may automatically prohibit an operator from manually controlling operation of the lift system 100 responsive to the controller 220 determining that the amount of weight that the lift system 100 is carrying exceeds a weight threshold.

Alternatively, if the controller 220 determines that the weight value is less than, does not meet, and/or does not exceed the weight threshold, flow of the method proceeds toward 510.

At 510, a determination is made if the number of passengers determined to be disposed within the passenger basket 106 matches a number of safety keys that are operably coupled with a corresponding safety anchor 214 of the passenger basket 106. For example, the controller 220 may determine the number of passenger that are disposed within the passenger basket 106 based on the weight value and may compare the number of passengers with a number of safety keys that have been matingly coupled with a corresponding safety anchor.

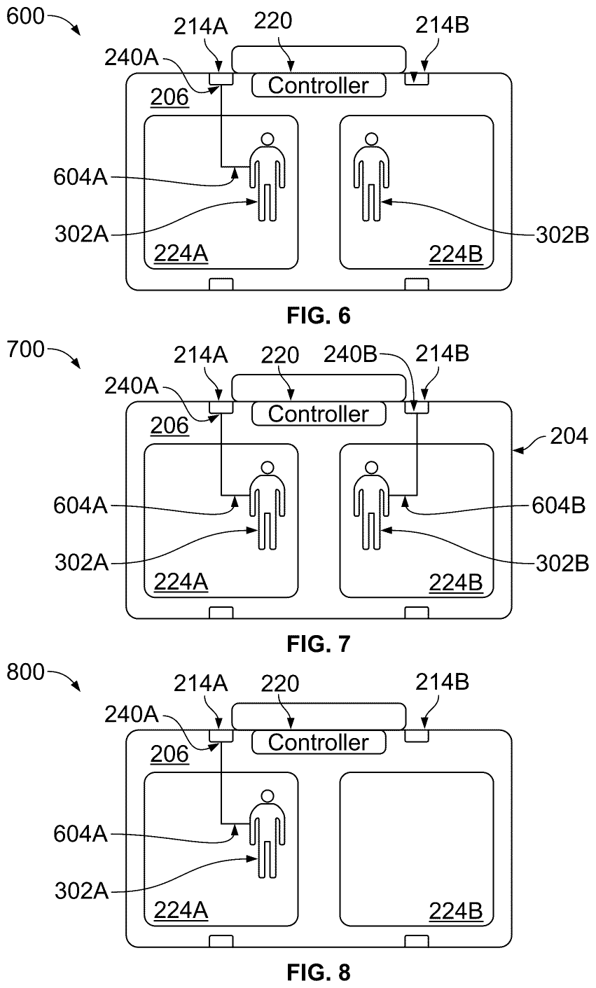

For example, referring to a first example 600 illustrated in FIG. 6, the controller may determine that two passengers 302A, 302B are positioned within the passenger basket 106 based on the data received from the load cell 114 and/or the weight detection devices 224A, 224B. Additionally, the controller may determine that a first safety key 240A is operably coupled with a first safety anchor 214A but that a second safety anchor 214B has not received a second safety key 240B. For example, a lanyard 604A extends between the first passenger 302A and the first safety key 214A that is operably coupled with the first safety anchor 214A. Alternatively, the second passenger 302B is not safely connected with any of the other safety anchors of the passenger basket 106. The controller 220 may identify that only one of the two passengers is safely anchored to the passenger basket 106 and the circuitry of the lift system 100 may prohibit operation of the lift system 100 responsive to determining that the number of passengers (e.g., two) is different than the number of safety keys that are operably coupled with a safety anchor (e.g., one).

If the number of passengers within the passenger basket 106 is different than the number of safety keys that have been coupled with a corresponding safety anchor, flow of the method proceeds toward 508 and the controller 220 prohibits any movement and/or operations of the lift system 100.

Alternatively, if the number of passengers within the passenger basket 106 is the same as the number of safety keys that are matingly coupled with a corresponding safety anchor, flow of the method proceeds toward 512.

At 512, the controller 220 may allow operation of the lift system 100 responsive to determining that the number of passengers within the passenger basket 106 is the same as the number of safety keys that are matingly coupled with a corresponding safety anchor of the passenger basket 106.

For example, referring to a second example 700 illustrated in FIG. 7, the controller 220 may determine that the first passenger 302A and the second passenger 302B are positioned within the passenger basket 106 based at least in part on the data received from the load cell 114 and/or the weight detection devices 224A, 224B. The controller 220 may also determine that two safety keys are operably coupled with a corresponding safety anchor. For example, the first safety key 240A that is connected to the first passenger 302A via the lanyard 604A is operably coupled with the first safety anchor 214A, and that the second safety key 240B that is connected to the second passenger 302B via the lanyard 604B is operably coupled with the second safety anchor 214B. In an alternative example, the first and/or second safety keys 214A, 214B may be operably coupled with any of the safety anchors. The controller 220 may identify that only both of the passengers are safely anchored to the passenger basket 106 and the circuitry of the lift system 100 may allow operation of the lift system 100 responsive to determining that the number of passengers (e.g., two) is the same as the number of safety keys that are operably coupled with a safety anchor (e.g., two).

As another example, referring to a third example 800 illustrated in FIG. 8, the controller 220 may determine that only the first passenger 302A is positioned within the passenger basket 106 based on the data received from the load cell 114 and/or the weight detection devices 224A, 224B. The controller 220 may also determine that the first safety key 240A is operably coupled with the first safety anchor 214A, and that the second safety anchor 214B has not received the second safety key 240B based on no other passenger being positioned within the passenger basket 106. The controller 220 may allow operation of the lift system 100 responsive to determining that the number of passengers (e.g., one) is the same as the number of safety keys that are operably coupled with a safety anchor (e.g., one).

In one example, the controller 220 may prohibit one or more operations of the lift system 100 responsive to determining i) that the weight value of the passenger basket 106 exceeds the determined weight threshold and ii) that the number of passengers is different than the number of safety keys that have been coupled with corresponding safety anchors. For example, the lift system 100 may be prohibited from moving regardless of the number of passengers being safely keyed into a corresponding anchor if the total weight value of passenger basket 106 exceeds the determined weight threshold.

Additionally, the controller 220 may prohibit one or more operations of the lift system 100 responsive to determining i) that the weight value is less than the determined weight threshold but ii) that the number of passengers is different than the number of safety keys that have been coupled with corresponding safety anchors.

Alternatively, the controller 220 may allow one or more operations of the lift system 100 responsive to determining i) that the weight value is less than the determined weight threshold and ii) that the number of passengers is the same as the number of safety keys that have been coupled with corresponding safety anchors.

In one or more examples, the controller 220 may continuously monitor the number of passengers and the number of safety keys that are being used while the lift system 100 is in use. For example, the controller may allow the passenger basket to be moved away from the ground surface responsive to determining that the number of occupants is the same as the number of safety keys coupled with corresponding safety anchors. Additionally, the controller may determine that the number of safety keys that are being used has changed.

For example, the controller 220 may identify that the first passenger 302A has disconnected from one of the safety anchors and has not re-attached to a different safety anchor, thereby determining that the number of occupants is not the same as the number of safety keys operably coupled with a corresponding safety anchor. In one example, the first passenger 302A may have manually separated the first safety key 240A from the first safety anchor 214A and may have forgotten to attach the first safety key 240A to a different safety anchor. In another example, the connection between the first safety key 240A and the first safety anchor 214A may have failed. For example, one or more components of the safety key and/or the safety anchor may have failed or otherwise compromised the connection between the key and the anchor. The controller may communicate an alert to the occupants of the passenger basket 106 indicating that one of the occupants is not securely anchored to the passenger basket 106, and may prohibit any movement or operations of the passenger basket 106 until the first passenger 302A is secured anchored to one of the safety anchors.

Further, the disclosure comprises examples according to the following clauses:
Clause 1: a fall protection system, comprising:
   plural safety anchors operably coupled with a passenger basket of a lift system, each of the plural safety anchors configured to receive a safety key;
   one or more sensors operably coupled with one or more of the passenger basket or a base of the lift system; and
   a controller including one or more processors configured to receive data from the one or more sensors, wherein the controller is configured to determine a weight value based on the data, the weight value corresponding to one or more passengers disposed within the passenger basket,
   wherein the controller is configured to determine a number of passengers disposed within the passenger basket based in part on the weight value, and
   wherein the controller is configured to control one or more operations of the lift system based at least in part on a comparison between the number of passengers disposed within the passenger basket and a number of safety keys operably coupled with a safety anchor.
Clause 2: the fall protection system of clause 1, wherein the controller is configured to prohibit the one or more operations of the lift system responsive to determining that the number of passengers disposed within the passenger basket is different than the number of safety keys operably coupled with safety anchors.
Clause 3: the fall protection system of clauses 1 or 2, wherein the controller is configured to allow the one or more operations of the lift system responsive to determining that the number of passengers disposed within the passenger basket is the same as the number of safety keys operably coupled with safety anchors.
Clause 4: the fall protection system of any of clauses 1-3, wherein the controller is configured to determine that one passenger is disposed within the passenger basket based in part on the weight value, and
   wherein the controller is configured to allow the one or more operations of the lift system responsive to determining that:
      i) the one passenger is disposed within the passenger basket,
      ii) a first safety key is operably coupled with a first safety anchor of the plural safety anchors, and
      iii) a second safety key is not operably coupled with a second safety anchor of the plural safety anchors.
Clause 5: the fall protection system of any of clauses 1-4, wherein the controller is configured to compare the weight value with a weight threshold, wherein the controller is configured to prohibit the one or more operations of the lift system responsive to determining that the weight value exceeds the weight threshold.
Clause 6: the fall protection system of clause 5, wherein the controller is configured to prohibit the one or more operations of the lift system responsive to determining that the weight value exceeds the weight threshold and that the number of passengers disposed within the passenger basket is different than the number of safety keys operably coupled with safety anchors.
Clause 7: the fall protection system of clause 5, wherein the controller is configured to prohibit the one or more operations of the lift system responsive to determining that the weight value exceeds the weight threshold and that the number of passengers disposed within the passenger basket is the same as the number of safety keys operably coupled with safety anchors.
Clause 8: the fall protection system of any of clauses 1-7, wherein the one or more sensors includes one or more of a load cell, a weight detection device, or a pressure sensor.
Clause 9: the fall protection system of any of clauses 1-8, wherein the one or more sensors operably coupled with one or more of the passenger basket or the base of the lift system includes one or more weight detection devices operably coupled with the passenger basket and a load cell operably coupled with the base of the lift system, wherein the one or more weight detection devices and the load cell are communicatively coupled with the controller.
Clause 10: the fall protection system of any of clauses 1-9, wherein the one or more operations of the lift system includes one or more of moving the passenger basket in a vertical direction between plural different elevations or moving one or more of the passenger basket or the base in a lateral direction.
Clause 11: a method, comprising:
   receiving data from one or more sensors operably coupled with one or more of a passenger basket or a base of a lift system, the data associated with a weight value corresponding to one or more passengers disposed within the passenger basket;
   determining a number of passengers disposed within the passenger basket based in part on the weight value;
   comparing the number of passengers disposed within the passenger basket with a number of safety keys operably coupled with a corresponding safety anchor, wherein plural safety anchors are configured to be operably coupled with the passenger basket; and
   controlling operation of the lift system based at least in part on the comparison between the number of passengers disposed within the passenger basket and the number of safety keys operably coupled with safety anchors.
Clause 12: the method of clause 11, further comprising prohibiting the one or more operations of the lift system responsive to determining that the number of passengers disposed within the passenger basket is different than the number of safety keys operably coupled with safety anchors.
Clause 13: the method of clauses 11 or 12, further comprising allowing the one or more operations of the lift system responsive to determining that the number of passengers disposed within the passenger basket is the same as the number of safety keys operably coupled with safety anchors.
Clause 14: the method of any of clauses 11-13, further comprising:
   determining that one passenger is disposed within the passenger basket based in part on the weight value; and
   allowing the one or more operations of the lift system responsive to determining that:
      i) the one passenger is disposed within the passenger basket,
      ii) a first safety key is operably coupled with a first safety anchor of the plural safety anchors, and
      iii) a second safety key is not operably coupled with a second safety anchor of the plural safety anchors.
Clause 15: the method of any of clauses 11-14, further comprising:
   comparing the weight value with a weight threshold; and
   prohibiting the one or more operations of the lift system responsive to determining that the weight value exceeds the weight threshold.
Clause 16: the method of clause 15, further comprising prohibiting the one or more operations of the lift system responsive to determining that the weight value exceeds the weight threshold and that the number of passengers disposed within the passenger basket is different than the number of safety keys operably coupled with safety anchors.
Clause 17: the method of clause 15, further comprising prohibiting the one or more operations of the lift system responsive to determining that the weight value exceeds the weight threshold and that the number of passengers disposed within the passenger basket is the same as the number of safety keys operably coupled with safety anchors.
Clause 18: a method, comprising:
   receiving data from one or more sensors operably coupled with one or more of a passenger basket or a base of a lift system, the data associated with a weight value corresponding to one or more passengers disposed within the passenger basket;
   determining a number of passengers disposed within the passenger basket based in part on the weight value;
   comparing the number of passengers disposed within the passenger basket with a number of safety keys operably coupled with a safety anchor, wherein plural safety anchors are configured to be operably coupled with the passenger basket; and
   one of:
   prohibiting the one or more operations of the lift system responsive to determining that the number of passengers disposed within the passenger basket is different than the number of safety keys operably coupled with safety anchors, or
   allowing the one or more operations of the lift system responsive to determining that the number of passengers disposed within the passenger basket is the same as the number of safety keys operably coupled with safety anchors.
Clause 19: the method of clause 18, further comprising:
   comparing the weight value with a weight threshold; and
   prohibiting the one or more operations of the lift system responsive to determining that the weight value exceeds the weight threshold.
Clause 20: the method of clause 19, further comprising:
   prohibiting the one or more operations of the lift system responsive to determining that the weight value exceeds the weight threshold and that the number of passengers disposed within the passenger basket is different than the number of safety keys operably coupled with safety anchors; and
   prohibiting the one or more operations of the lift system responsive to determining that the weight value exceeds the weight threshold and that the number of passengers disposed within the passenger basket is the same as the number of safety keys operably coupled with safety anchors.

As described herein, examples of the present disclosure provide systems and methods for verifying a number of passengers that may be disposed in a passenger basket of a lift system based on a weight value of the passenger basket, and verifying a number of safety keys that have been coupled with a corresponding safety anchor of the passenger basket. The verification of the number of passengers based on weight, and the verification of the number of safety keys coupled with corresponding safety anchors provides an intelligent security system that ensures that each passenger positioned within the passenger basket is secured to the passenger basket. The systems and methods described herein provide an intelligent safety system that eliminates the need for the passengers of the passenger basket to manually remember to anchor to the passenger basket, thereby eliminating the risk of human error.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A fall protection system, comprising:
plural safety anchors operably coupled with a passenger basket of a lift system, each of the plural safety anchors configured to receive a safety key;
one or more sensors operably coupled with one or more of the passenger basket or a base of the lift system; and
a controller including one or more processors configured to receive data from the one or more sensors, wherein the controller is configured to determine a weight value based on the data, the weight value corresponding to one or more passengers disposed within the passenger basket,
wherein the controller is configured to determine a number of passengers disposed within the passenger basket based in part on the weight value, and
wherein the controller is configured to control one or more operations of the lift system based at least in part on a comparison between the number of passengers disposed within the passenger basket and a number of safety keys operably coupled with a safety anchor.

2. The fall protection system of claim 1, wherein the controller is configured to prohibit the one or more operations of the lift system responsive to determining that the number of passengers disposed within the passenger basket is different than the number of safety keys operably coupled with safety anchors.

3. The fall protection system of claim 1, wherein the controller is configured to allow the one or more operations of the lift system responsive to determining that the number of passengers disposed within the passenger basket is the same as the number of safety keys operably coupled with safety anchors.

4. The fall protection system of claim 1, wherein the controller is configured to determine that one passenger is disposed within the passenger basket based in part on the weight value, and
wherein the controller is configured to allow the one or more operations of the lift system responsive to determining that:
i) the one passenger is disposed within the passenger basket,
ii) a first safety key is operably coupled with a first safety anchor of the plural safety anchors, and
iii) a second safety key is not operably coupled with a second safety anchor of the plural safety anchors.

5. The fall protection system of claim 1, wherein the controller is configured to compare the weight value with a weight threshold, wherein the controller is configured to prohibit the one or more operations of the lift system responsive to determining that the weight value exceeds the weight threshold.

6. The fall protection system of claim 5, wherein the controller is configured to prohibit the one or more operations of the lift system responsive to determining that the weight value exceeds the weight threshold and that the number of passengers disposed within the passenger basket is different than the number of safety keys operably coupled with safety anchors.

7. The fall protection system of claim 5, wherein the controller is configured to prohibit the one or more operations of the lift system responsive to determining that the weight value exceeds the weight threshold and that the number of passengers disposed within the passenger basket is the same as the number of safety keys operably coupled with safety anchors.

8. The fall protection system of claim 1, wherein the one or more sensors includes one or more of a load cell, a weight detection device, or a pressure sensor.

9. The fall protection system of claim 1, wherein the one or more sensors operably coupled with one or more of the passenger basket or the base of the lift system includes one or more weight detection devices operably coupled with the passenger basket and a load cell operably coupled with the base of the lift system, wherein the one or more weight detection devices and the load cell are communicatively coupled with the controller.

10. The fall protection system of claim 1, wherein the one or more operations of the lift system includes one or more of moving the passenger basket in a vertical direction between plural different elevations or moving one or more of the passenger basket or the base in a lateral direction.

11. A method, comprising:
receiving data from one or more sensors operably coupled with one or more of a passenger basket or a base of a lift system, the data associated with a weight value corresponding to one or more passengers disposed within the passenger basket;
determining a number of passengers disposed within the passenger basket based in part on the weight value;
comparing the number of passengers disposed within the passenger basket with a number of safety keys operably coupled with a corresponding safety anchor, wherein plural safety anchors are configured to be operably coupled with the passenger basket; and
controlling operation of the lift system based at least in part on the comparison between the number of passengers disposed within the passenger basket and the number of safety keys operably coupled with safety anchors.

12. The method of claim 11, further comprising prohibiting the one or more operations of the lift system responsive to determining that the number of passengers disposed within the passenger basket is different than the number of safety keys operably coupled with safety anchors.

13. The method of claim 11, further comprising allowing the one or more operations of the lift system responsive to determining that the number of passengers disposed within the passenger basket is the same as the number of safety keys operably coupled with safety anchors.

14. The method of claim 11, further comprising:
determining that one passenger is disposed within the passenger basket based in part on the weight value; and
allowing the one or more operations of the lift system responsive to determining that:
i) the one passenger is disposed within the passenger basket,
ii) a first safety key is operably coupled with a first safety anchor of the plural safety anchors, and
iii) a second safety key is not operably coupled with a second safety anchor of the plural safety anchors.

15. The method of claim 11, further comprising:
comparing the weight value with a weight threshold; and
prohibiting the one or more operations of the lift system responsive to determining that the weight value exceeds the weight threshold.

16. The method of claim 15, further comprising prohibiting the one or more operations of the lift system responsive to determining that the weight value exceeds the weight threshold and that the number of passengers disposed within the passenger basket is different than the number of safety keys operably coupled with safety anchors.

17. The method of claim 15, further comprising prohibiting the one or more operations of the lift system responsive to determining that the weight value exceeds the weight threshold and that the number of passengers disposed within the passenger basket is the same as the number of safety keys operably coupled with safety anchors.

18. A method, comprising:
receiving data from one or more sensors operably coupled with one or more of a passenger basket or a base of a lift system, the data associated with a weight value corresponding to one or more passengers disposed within the passenger basket;
determining a number of passengers disposed within the passenger basket based in part on the weight value;
comparing the number of passengers disposed within the passenger basket with a number of safety keys operably coupled with a safety anchor, wherein plural safety anchors are configured to be operably coupled with the passenger basket; and
one of:
prohibiting the one or more operations of the lift system responsive to determining that the number of passengers disposed within the passenger basket is different than the number of safety keys operably coupled with safety anchors, or allowing the one or more operations of the lift system responsive to determining that the number of passengers disposed within the passenger basket is the same as the number of safety keys operably coupled with safety anchors.

19. The method of claim 18, further comprising:
comparing the weight value with a weight threshold; and
prohibiting the one or more operations of the lift system responsive to determining that the weight value exceeds the weight threshold.

20. The method of claim 19, further comprising:
prohibiting the one or more operations of the lift system responsive to determining that the weight value exceeds the weight threshold and that the number of passengers disposed within the passenger basket is different than the number of safety keys operably coupled with safety anchors; and
prohibiting the one or more operations of the lift system responsive to determining that the weight value exceeds the weight threshold and that the number of passengers disposed within the passenger basket is the same as the number of safety keys operably coupled with safety anchors.
